(19) United States
(12) Patent Application Publication
(10) Pub. No.: US 2021/0001531 A1
(43) Pub. Date: Jan. 7, 2021

(54) METHOD AND APPARATUS FOR ULTRASONIC EXTRUSION CONTROL

(71) Applicant: Novatec, Inc., Baltimore, MD (US)

(72) Inventor: Robert H. BESSEMER, Allison Park, PA (US)

(73) Assignee: Novatec, Inc., Baltimore, MD (US)

(21) Appl. No.: 16/913,378

(22) Filed: Jun. 26, 2020

Related U.S. Application Data
(60) Provisional application No. 62/869,776, filed on Jul. 2, 2019.

(51) Int. Cl. B29C 48/92; B29C 48/09; B29C 48/88

(52) U.S. Cl. CPC B29C 48/92; B29C 48/09; B29C 48/919; B29C 2948/92123; B29C 2948/92019; B29C 2948/92514; B29C 48/9115

(57) ABSTRACT

An ultrasonic transducer fixture has an entrance and an exit for tubular extrudate passing therethrough; ultrasonic transducers within a closed chamber in position for passage of the tubular extrudate therebetween; and a vacuum source communicating with the chamber interior for maintaining sub-atmospheric pressure within the chamber. The water level in the chamber is controlled so that the ultrasonic transducers remain immersed in the water.

### STATEMENT REGARDING FEDERALLY SPONSORED RESEARCH OR DEVELOPMENT

Not applicable.

This invention was conceived and developed entirely using private source funding; this patent application is being filed and paid for entirely by private source funding.

### CROSS-REFERENCE TO RELATED APPLICATIONS

This application claims the benefit under 35 U.S.C. 119(e) of U.S. provisional application No. 62/869,776, filed Jul. 2, 2019, the contents of which are incorporated by reference herein in their entirety.

### DESCRIPTION OF THE PRIOR ART

Plastic tubes of small diameter are fabricated conventionally by extruding polymer material through an extrusion die. As the material is forced through the die, the tube assumes the shape of the die. The tube is drawn from the die (with the draw-down ratio particular to each material type) by a pulling mechanism, which pulls the tube through a cooling medium downstream of the die, at a constant rate to maintain size.

It is necessary to monitor the outer diameter and the thickness of the wall of the tubular extrudate as it exits the die, for quality control and tolerancing purposes. It is known to use ultrasonic sensors/transducers to measure and monitor these two parameters of the tubular extrudate. The ultrasonic sensors/transducers do not contact the tubular extrudate; the tubular extrudate and the ultrasonic sensors/transducers are immersed in the cooing medium, i.e., water, contained in an open water tank or a closed a vacuum tank. The water or vacuum tank typically is positioned immediately adjacent to the extrusion die such that the tubular extrusion exiting the die immediately enters the tank, at a position below the surface of the water in the tank.

Typically, the ultrasonic transducers have been mounted within the tank at a distance of about 12 to about 18 inches from the entry point. This distance creates the potential for inaccuracy, as the distance from the “hot” die to the initial measurement point is related to a control loop; and a factor of ten often is used to determine the update control loop distance. This distance from the hot die is the initial measurement position were both outer diameter (“OD”) and wall thickness can be measured. Microprocessors typically execute controlling functions using programmed loops. A programmed loop has set priorities, and thus takes time to make programmed outputs. While this programmed loop is taking place, material is travelling through the tank and not being corrected to specifications. Thus, if the distance from the hot die face to the transducer is 12 inches, the extrudate travels a distance of 120 inches (ten times the distance from the hot die to the sensor) before corrections are implemented based on the measured parameters.

With the transducers inside the water or vacuum tank, tube floatation can occur, which in turn can lead to the tube and/or transducers not being correctly orientated with respect to the tube being measured. As a result, transducer holders have become complex and may incorporate a series of rollers or guides which can cause variable drag, especially when used within a vacuum tank and depending on the extrusion process used, namely, free extrusion, non-contact tube vacuum sizing, or contact tube vacuum sizing.

When extruding small tubing using known apparatuses, it can be difficult to orient the water or vacuum tank such that the tube enters the transducer holder in the center thereof. Correct orientation of the tube is necessary in order to obtain accurate measurements of the outer diameter and wall thickness of the extruded tube; and to avoid contact between the tube and the tank or transducer holder which can result in drag, and distortion size variations in the tube.

### SUMMARY OF THE INVENTION

In one of its aspects, the disclosed technology provides a method for ultrasonically measuring the outer diameter of a tubular extrudate exiting an extrusion die by providing a chamber having inlet and exit openings for passage therethrough of the moving tubular extrudate. The method proceeds by positioning a plurality of ultrasonic transducers spaced from the moving tubular extrudate, with the ultrasonic transducers desirably being in opposed-paired, mutually-opposing disposition within the chamber. The method then proceeds by introducing water into the chamber and provides independent water level control in the chamber in an amount sufficient to cover the transducers within the chamber. The method further proceeds by automatically controlling and maintaining the chamber's internal pressure at a level sufficiently below atmospheric to preclude escape of water from the chamber through the inlet and exit openings as the tubular extrudate moves through the chamber.

In another aspect of the disclosed technology, the method further includes monitoring the water level in the chamber relative to the transducers, introducing water into the chamber whenever chamber water level falls sufficiently that the top of a transducer is exposed, and continuously introducing water into the chamber until the chamber water level is above the transducers by a pre-selected amount.

In another aspect of the disclosed technology, the method further includes continuously monitoring the chamber's internal pressure; optionally lowering or raising the internal pressure while flooding or draining water from the chamber in response to the chamber internal pressure; and maintaining the chamber internal pressure at a level sufficiently below atmospheric to preclude escape of water from the chamber through the inlet and exit openings as the tubular extrudate moves through the chamber.

In another one of its aspects, the disclosed technology provides an ultrasonic transducer fixture for measuring parameters of a moving tubular extrudate, including a chamber having an entrance and an exit for tubular extrudate passing therethrough; a holder within the chamber; a plurality of ultrasonic transducers connected to the holder and positioned in paired disposition for passage of the tubular extrudate therebetween; and a vacuum source communicating with the chamber interior for maintaining chamber internal pressure at a selected level below atmospheric.

In the fixture aspect of the technology, a vacuum source can be provided for maintaining the chamber internal pressure at a level sufficiently below atmospheric to preclude escape of water from the chamber through the entrance and exit as tubular extrudate moves through the chamber. The fixture aspect of the technology further can include a system to independently control the water level in the chamber relative to the transducers, with a sensor connected to the chamber for monitoring water level as a part of that system. In another aspect of the disclosed technology, the system can include a pump for introducing water into the chamber whenever the chamber water level falls sufficiently that the top of a transducer is exposed; and a control, connected to the sensor and to the pump, for continuously introducing water into the chamber until the chamber water level is above the tops of the transducers by a pre-selected amount.

In another aspect, the disclosed technology relates to a method for ultrasonically measuring an outer diameter of a tubular extrudate exiting an extrusion die. The method includes providing a closed chamber having inlet and exit openings for passage therethrough of the tubular extrudate; positioning a plurality of ultrasonic transducers within the chamber and spaced from the tubular extrudate; controlling a water level in the chamber sufficiently to cover the transducers; and automatic controlling and maintaining an internal pressure of the chamber at a level sufficiently below atmospheric pressure to preclude escape of water from the chamber through the inlet and exit openings as the tubular extrudate moves through the chamber.

In another aspect of the technology, the method further includes monitoring the water level in the chamber relative to the transducers; introducing water into the chamber whenever the water level falls sufficiently that a top of one or more of the ultrasonic transducers is exposed; and continuing introducing water into the chamber until the water level is above the tops of the one or more ultrasonic transducers by a preselected amount.

In another aspect of the technology, the method further includes continuously monitoring the internal pressure of the chamber; and lowering or raising the internal pressure of the chamber while flooding or draining water from the chamber to maintain the internal pressure of the chamber at a level sufficiently below atmospheric pressure to preclude escape of water from the chamber through the inlet and exit openings as the tubular extrudate moves through the chamber.

In another aspect of the technology, the method further includes determining the outer diameter of the tubular extrudate based on an output of the one or more ultrasonic transducers.

In another aspect of the technology, the method further includes providing a holder on which the one or more ultrasonic transducers are mounted; and determining a position of the tubular extrudate in relation to the holder based on an output of the one or more ultrasonic transducers.

In another aspect of the technology, the method further includes adjusting a position of the chamber in relation to the tubular extrudate.

In another aspect of the technology, adjusting a position of the chamber in relation to the tubular extrudate includes moving the chamber so that the tubular extrudate is substantially centered within the holder.

In another aspect of the technology, the method further includes mounting the chamber on a cooling-medium tank.

In another aspect, the disclosed technology relates to an ultrasonic transducer fixture for measuring parameters of a moving tubular extrudate. The fixture includes a closed chamber having an interior, and an entrance and an exit for passage of the tubular extrudate through the interior. The fixture also includes a holder positioned within the interior of the chamber; a plurality of ultrasonic transducers mounted on the holder and positioned for passage of the tubular extrudate therebetween; and a vacuum source in fluid communication with the interior of the chamber and configured to maintain an internal pressure of the chamber at a level below atmospheric pressure. The fixture further includes a pump in fluid communication with the interior of the chamber; and a control electrically connected to the pump and configured to generate an output that, when received by the pump, causes the pump to introduce water into the interior of the chamber to maintain a water level in the interior of the chamber above the tops of the one or more ultrasonic transducers.

In another aspect of the technology, the control is electrically connected to the vacuum source and is further configured to generate another output that, when received by the vacuum source, causes the vacuum source to maintain the internal pressure of the chamber at a level sufficiently below atmospheric pressure to preclude escape of the water from the chamber through the entrance and exit as the tubular extrudate moves through the chamber.

In another aspect of the technology, the fixture further includes a first iris valve mounted at the entrance of the chamber for passage therethrough of the tubular extrudate; and a second iris valve mounted at the exit of the chamber for passage therethrough of the tubular extrudate.

In another aspect of the technology, the holder has a bore formed therein for passage therethrough of the tubular extrudate.

In another aspect of the technology, the ultrasonic transducers are arranged on the holder in opposed pairs.

In another aspect of the technology, the chamber has a first substantially vertical wall having the entrance to the chamber formed therein; and a second substantially vertical wall having the exit to the chamber formed therein.

In another aspect of the technology, the chamber is configured to be mounted on a cooling-medium tank.

In another aspect of the technology, the fixture further includes a water level sensor electrically connected to the control and configured to sense the water level in the interior of the chamber.

In another aspect, the disclosed technology relates to an apparatus having an ultrasonic transducer fixture. The fixture includes a vacuum chamber having an entrance for receiving a tubular extrudate from an extrusion die, and an exit. The fixture also includes a holder within the vacuum chamber; a plurality of ultrasonic transducers mounted on the holder and positioned for passage of the tubular extrudate therebetween; and a vacuum source in fluid communication with an interior of the vacuum chamber and configured to maintain an internal pressure of the vacuum chamber at a level below atmospheric pressure.

The apparatus further includes a cooling-medium tank. The ultrasonic transducer fixture is mounted on the cooing-medium tank, and the cooling-medium tank has an entrance configured to receive the tubular extrudate after the tubular extrudate exits the vacuum chamber.

In another aspect of the technology, the cooling-medium tank and the vacuum chamber are configured to be movable in relation to the extrusion die.

In another aspect of the technology, the apparatus further includes a signal processing device communicatively coupled to the ultrasonic transducers and configured to determine an outer diameter and a relative position of the tubular extrudate based on outputs of the ultrasonic transducers.

In another aspect of the technology, the apparatus further includes one or more actuators mounted on the cooling-medium tank and configured to move the cooling-medium tank; and a controller communicatively coupled to the one or more actuators and the signal processing device. The controller is configured to generate an output that, when received by the one or more actuators, causes the one or more actuators to move the cooling-medium tank and the fixture.

In another aspect of the technology, the output of the controller, when received by the one or more actuators, causes the one or more actuators to move the cooling-medium tank and the fixture so that the tubular extrudate becomes centered within the holder.

In another aspect of the technology, the apparatus further includes a video display communicatively coupled to the signal processing device. The signal processing device, in response to the outputs of the ultrasonic transducers, is further configured to generate an output that, when received by the video display, causes the video display to display an image representative of an actual position of the tubular extrudate in relation to the one or more ultrasonic transducers, and in relation to an established target defined by the centerline of an intended path of the tubular extrudate through the holder and the tank.

The following detailed description is merely exemplary in nature and is not intended to limit the described embodiments of the invention or uses of the described embodiments. As used herein, the words “exemplary” and “illustrative” mean “serving as an example, instance, or for illustration.” Any implementation or embodiment or abstract disclosed herein as being “exemplary” or “illustrative” is not necessarily to be construed as preferred or advantageous over other implementations, aspects, or embodiments. All of the implementations or embodiments described in the detailed description are exemplary implementations and embodiments provided to enable persons of skill in the art to make and to use the implementations and embodiments as disclosed below, to otherwise practice the invention, and are not intended to limit the scope of the invention, which is defined by the claims.

Furthermore, by this disclosure, there is no intention on the part of the Applicant to be bound by any express or implied theory presented in the preceding materials, including but not limited to the summary of the invention or the description of the prior art, or in the following detailed description of the technology. It is to be understood that the specific implementations, devices, processes, aspects, and the like illustrated in the attached drawings and described in the following portion of the application, usually referred to as the “specification,” are simply exemplary embodiments of the technology defined in the claims. Accordingly, specific dimensions and other physical characteristics relating to the embodiments disclosed herein are not to be considered as limiting as respecting the invention unless the claims or the specification expressly state otherwise.

### DESCRIPTION OF THE DRAWINGS

FIG. 1 is a schematic view in side elevation of ultrasonic extrusion control apparatus in accordance with the invention.

FIG. 2 is a schematic view in side elevation of a vacuum chamber portion of the ultrasonic extrusion control apparatus illustrated schematically in FIG. 1.

FIG. 3 is a schematic view in elevation taken at arrows A-A in FIG. 2 of an ultrasonic sensor holder for use with the ultrasonic extrusion control apparatus illustrated in FIGS. 1 and 2.

FIG. 4 is a schematic view of various electrical components of the ultrasonic extrusion control apparatus illustrated in FIGS. 1 and 2.

### DESCRIPTION OF THE INVENTIONS

In one of its aspects, the disclosed technology provides a water-filled and water-level controlled vacuum chamber housing ultrasonic sensors/transducers for measuring the diameter of a tubular extrudate. The housing is independent of the tank containing the cooling medium for the extrudate. The chamber ideally is mounted on the outside of the cooling-medium tank, between the extrusion die and the tank.

Tubular extrudate enters and exits the water-level controlled vacuum chamber, passing between a number of ultrasonic sensor/transducers that are immersed in the water in the chamber. The chamber is maintained under specific vacuum such that the entry and exit of the extrudate from the chamber prevents the water from exiting the chamber. The vacuum, namely sub-atmospheric pressure, in the chamber prevents water from leaking out of the chamber around the tubular extrudate where the tubular extrudate enters and exits the chamber; and the water serves as a hydraulic seal for the extrudate passing through the chamber. The chamber is necessarily sealed in order that the vacuum, i.e., sub-atmospheric pressure, may be maintained therein. The shorter distance (by virtue of the chamber ideally being mounted on the upstream exterior side of a cooling tank located essentially immediately adjacent to the die) from the hot die enhances potential tolerancing of the extrudate; can make it easier to center the die visually when correcting for non-concentricity of the tube and the die; and can eliminate any need to support the extrudate using contacting structures, such as rollers, as the extrudate passes through the chamber and the cooling-medium tank.

The chamber, and optionally the cooling-medium tank on which the chamber is mounted, can be mounted to be movable horizontally and vertically in response to signals generated by the ultrasonic sensor/transducers, so as to keep the chamber, and optionally the cooling-medium tank, in the proper position, with the extrudate being “centered” as it passes between pairs of the ultrasonic sensors/transducers as the extrusion process proceeds. The centering of the extrudate can automated, using the signals from the ultrasonic sensor/transducers; or may be performed manually, working from a video display generated from the signals received from the ultrasonic sensor/transducers.

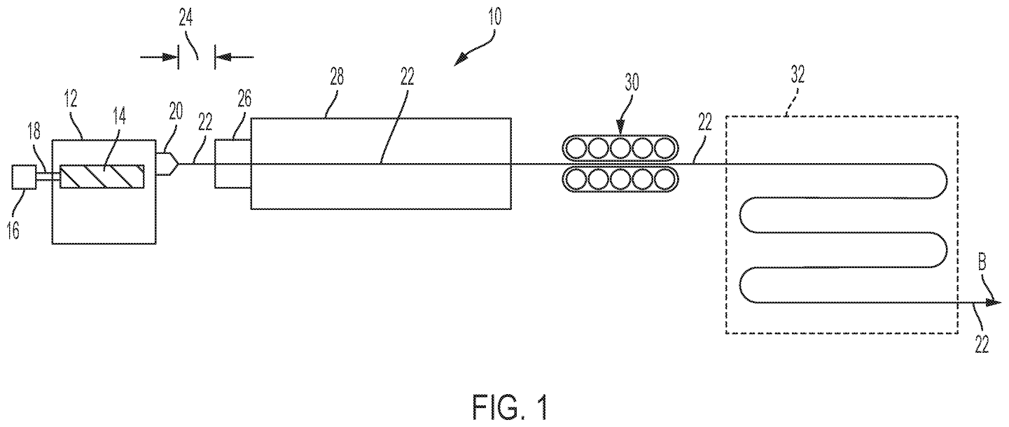

Referring to the drawings in general and to FIG. 1 in particular, an ultrasonic extrusion control apparatus is illustrated in FIG. 1 and is designated generally using the reference character 10. Apparatus 10 includes an extruder 12 having an extrusion screw 14. Extruder 12 further includes a motor 16 that turns a drive shaft 18 connected to extruder screw 14 for rotation of extruder screw 14 during operation of the extruder 12.

As the extruder screw 14 rotates and thermoplastic polymeric material is fed to extruder screw 14 through a feed apparatus not illustrated in FIG. 1, the rotation of extruder screw 14 works the thermoplastic material and urges the thermoplastic material forward and to the right in FIG. 1, thereby turning the thermoplastic material into a highly-viscous, early molten material. Continued rotation of extruder screw 14 results in the highly-viscous thermoplastic material being forced through and out of an extruder die 20, with the viscous material assuming a shape according to the interior configuration of die 20. This extrudate, designated 22 in the drawings, is desirably tubular in structure. Most desirably, the extrudate 22 has a very thin wall and a very small central bore formed therein, as extrudate 22 exits die 20.

Shortly after exiting die 20, extrudate 22 enters a size vacuum chamber designated 26 in FIG. 1. Distance or space between die 20 and vacuum chamber 26 is referred to as “hot die space” and is designated generally 24 in FIG. 1. Note that hot die space 24 is not a structural element but rather denotes space traversed by extrudate 22 as it travels from die 20 to vacuum chamber 26.

Vacuum chamber 26 desirably is mounted on a cooling-medium tank 28, which can be either an open water tank or a closed vacuum tank, with an open water tank being preferable. Extrudate 22 passes through vacuum chamber 26 and through tank 28, all as illustrated in FIG. 1.

Extrudate 22 is pulled through vacuum chamber 26 and tank 28 by a puller assembly designated generally 30 in FIG. 1. Puller assembly 30 desirably constitutes two endless belts positioned in an opposed disposition with respect to one another, with extrudate 22 contacting the belts and being pulled from left to right in FIG. 1 by action by the endless belts. The belts of puller assembly 30 have not been numbered in FIG. 1, to enhance drawing clarity. Similarly, contact between extrudate 22 and the belts of puller assembly 30 has not been shown, to enhance drawing clarity.

After exiting puller assembly 30, extrudate 22 can enter a secondary cooling-medium tank 32, which is preferably filled with water. Secondary cooling-medium tank 32 is optional as indicated by the dotted line structure defining secondary cooling-medium tank 32 in FIG. 1. Extrudate 22 preferably resides within secondary cooling-medium tank 32 for a time sufficient to allow extrudate 22 to cool to a desired level so that the tubular structure of extrudate 22 is relatively fixed. Residence of extrudate 22 within secondary cooling-medium tank 32 may be via a curved path as illustrated in FIG. 1, or may be in a straight path. In any event, extrudate 22 eventually exits secondary cooling-medium tank 32 in a direction indicated by arrow B in FIG. 1.

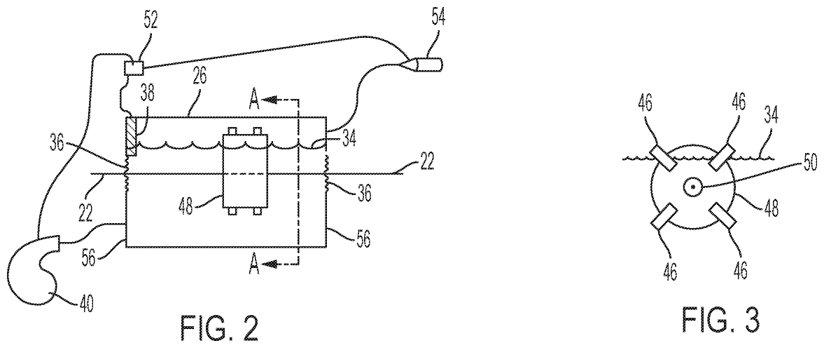

FIG. 2 illustrates vacuum chamber 26, and components that are ancillary thereto and necessary for operation thereof, in more detail. Vacuum chamber 26 may be of any shape; the shape of vacuum chamber 26 is not critical. Vacuum chamber 26 has connected thereto a water pump shown schematically and designated 40 in FIG. 2. A vacuum pump 54 also is connected to vacuum chamber 26. Water pump 40 supplies water to the interior of vacuum chamber 26. Vacuum pump 54 draws air to create a sub-atmospheric pressure or vacuum within vacuum chamber 26 above the level of the water in the vacuum chamber 26. Water level in vacuum chamber 26 is indicated by water surface 34, which is a horizontal water surface within vacuum chamber 26.

Extrudate 22 enters vacuum chamber 26 traveling from left to right in FIG. 2. Openings in the vertical walls 56 of vacuum chamber 26 allow passage of extrudate 22 through the water contained within vacuum chamber 26. Due to the sub-atmospheric pressure maintained above water surface 34 by operation of vacuum pump 54, sub-atmospheric pressure is maintained within vacuum chamber 26. As a result, water does not escape from the openings in vertical walls 56 of vacuum chamber 26.

The vertical character of the water surfaces at the apertures of vertical walls 56 of vacuum chamber 26 is denoted by indicator numerals 36 in FIG. 2. A water level sensor 38 is provided within vacuum chamber 26 to monitor the level of horizontal water surface 34. Water level sensor 38 is connected to a vacuum/water level control 52 by suitable wiring, shown but not numbered in FIG. 2. Similarly, vacuum/water level control 52 connects to water pump 40 and to vacuum pump 54 by suitable electrical lines shown but not numbered in FIG. 2.

An ultrasonic transducer holder 48 is positioned within vacuum chamber 26 for passage therethrough of extrudate 22. Holder 48 holds a plurality of ultrasonic transducers 46. The ultrasonic transducers 46 are positioned to be in close proximity to extrudate 22 passing through vacuum chamber 26 and holder 48.

Referring to FIG. 3, holder 48 is shown in schematic form with four ultrasonic transducers 46 being positioned in holder 48, with ultrasonic transducers 46 being arranged in opposed pairs. The ultrasonic transducers 46 can be arranged in other configurations in alternative embodiments. Ultrasonic transducers 46 are in radial orientation with respect to extrudate 22. A bore 50 is provided in holder 48 for passage of extrudate 22 through holder 48.

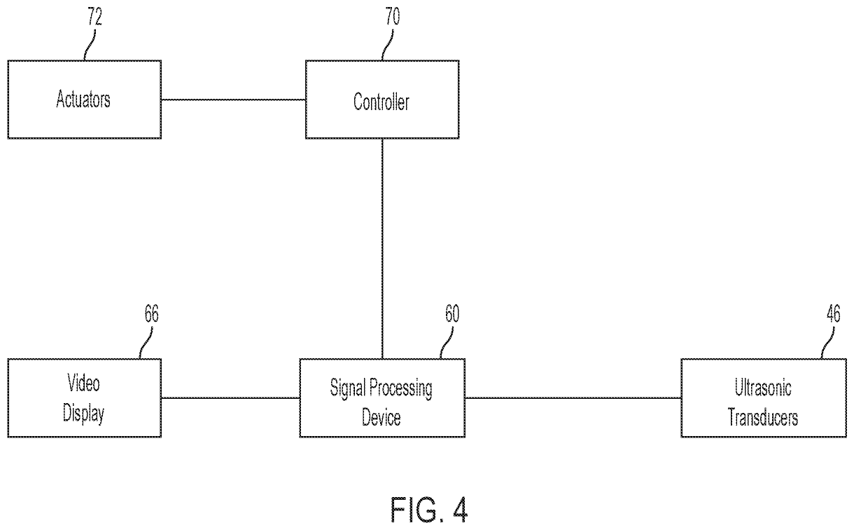

As illustrated in FIG. 3, holder 48 is positioned so that ultrasonic transducers 46 are located below the level of the horizontal water surface 34 within vacuum chamber 26, and are fully immersed in the water. This is necessary to facilitate transmission of the ultrasonic waves that are emitted by the ultrasonic transducers 46 and reflected back toward the ultrasonic sensors 46 upon contact with the extrudate 22. Each ultrasonic transducer 46 generates an output signal indicative of the distance from the face of ultrasonic transducer 46 to the adjacent surface of the outer wall of the extrudate 22. The output signals of ultrasonic transducers 46 are provided to a suitable signal processing device for conversion into data regarding the size, i.e., the “hot” outer diameter, of extrudate 22; as well as the position of extrudate 22 in relation to the bore 50 in holder 48. The signal processing device is denoted in FIG. 4 by the reference character 60. The signal processing device 60 can be, for example, a UMAC® measuring system available from Zumbach Electronic AG.

It is further within the scope of this technology to use ultrasonic transducers 46 as location devices to allow visual centering of the extrudate tube 22 as it passes through the transducer holder 48 and the tank 28. Specifically, signal processing device 60 is communicatively coupled to a video display 66, depicted schematically in FIG. 4. Signal processing device 60 is configured to process the outputs of ultrasonic transducers 46, and based on this processing, generate and display on video display 66 video images depicting the location of extrudate 22 in relation to ultrasonic transducers 46, and in relation to an established target defined by the centerline of the desired path of the extrudate 22 through the bore 50 of transducer holder 48, and cooling-medium tank 28. The displayed image can include cross hairs to indicate the centerline of the desired path of extrudate 22.

Cooling-medium tank 28 can be provided with provisions (not shown) that permit an operator to manually adjust the vertical and horizontal positions of tank 28, and the attached vacuum sensing chamber 26, in relation to extrudate 22. The operator can use these provisions in conjunction with the image displayed on video display 66 to adjust the position of cooling-medium tank 28 and vacuum sensing chamber 26 so as to align extrudate 22 and the desired path of extrudate 22 through transducer holder 48 and cooling-medium tank 28.

It is further within the scope of the disclosed technology to automate the adjustment of position of the vacuum sensing chamber 26 and cooling-medium tank 28. For example, FIGS. 2 and 4 depict a controller 70, and servo actuators 72. The controller 70 is communicatively coupled to servo actuators 72 and ultrasonic transducers 46. Controller 70 comprises a processor, such as a microprocessor; a memory having computer-executable instructions stored thereon; suitable input-output circuitry facilitating external communications between controller 70, servo actuators 72, and ultrasonic transducer 46; and a bus facilitating internal communications between the processor, the memory, and the input-output circuitry. The controller 70 can include other components, the disclosure of which is not necessary to an understanding of the disclosed technology.

The controller 70 receives a signal from signal processing device 60 indicating the position of extrudate 22 in relation to the desired path of travel of extrudate 22 through bore 50 of transducer holder 48, and cooling-medium tank 28. The computer executable instructions, when executed on the processor, cause the controller 70 to generate outputs to servo actuators 72 in response to the extrudate-position-information generated by signal processing device 60. The output of the controller 70 causes the servo actuators 72 to move tank 28, and the attached vacuum sensing chamber 26, horizontally and vertically so that the positions of transducer holder 40 the tank 28 are continuously adjusted to maintain the centerline of the extrudate 22 at the desired position in relation to the transducer holder 40 and tank 28 as the extrudate 22 passes through those components.

Such use of the ultrasonic transducers 46 as a location device, allowing manual visual, or automated centering of the extrudate 22 as it passes through the transducer holder 48 and vacuum sensing chamber 26, is believed to represent a significant advance over conventional practice. Under current conventional practice, it is extremely difficult to center the extrudate 22, which may be less than 0.01 inch in diameter as the extrudate 22 enters tooling at the entrance to a water or vacuum tank such as the tank 28.

In one of its manifestations, the technology may be considered as an ultrasonic transducer holder, which is a vacuum chamber unto itself, having a means of water entry, means of water exit, and a vacuum or suction port enabling vacuum to be drawn and thereby enabling water to be used as a hydraulic seal, with the vacuum being used at varying levels to control water flow out of the chamber and thus to control water and extrudate stability. The water level control is configured such that the water level is always controlled so that the sensing faces of ultrasonic transducers 46 are immersed in the water within the chamber. A closed loop vacuum system with an air/water separation filter is interfaced with the vacuum chamber 26 to enable stable operation. The differential pressure between the interior of the vacuum chamber 26 and the outer atmosphere is continuously adjusted so that the water in the vacuum chamber 26 will not come out of the vacuum chamber 26 no matter the atmospheric pressure at the locale at which the vacuum chamber 26 is in operation.

Configuring the structure in which transducers 46 reside asits own vacuum chamber 26 allows the vacuum chamber 26 to be mounted on the outside wall of a tank, such as the cooling-medium thank 28, at the extrudate entry aperture to the tank 28. In this manner, the ultrasonic transducers 26 and the vacuum chamber 26 can be positioned as close as possible to the extruder die 20 from which the extrudate 22 emerges.

An iris-type valve (not shown) can be used at the entrance and at the exit of the vacuum chamber 26, to minimize the space between the tubular extrudate 22 and the entry to the vacuum chamber 26 and thereby minimize the amount of any water that may escape in the event of a breakdown of the vacuum system and the resulting breakdown of the sub-atmospheric pressure within the chamber.

In one typical implementation of the technology, the length of a the vacuum chamber 26 through which the extrudate 22 travels may be as little as one inch or one and one-half inches. Minimizing the length of travel of the extrudate 22 through the water as the extrudate 22 passes the ultrasonic transducers 46 contributes to stability to extrudate 22, since the smaller the distance the extrudate 22 travels through the water, the less the flotation force on the extrudate 22. Minimizing the flotation force is desirable, because the flotation force tends to move the extrudate 22, which in turn can result in distortion and size variations in extrudate 22.

Because the vacuum sensing chamber 26 is closed, and is maintained at sub-atmospheric pressure, there is little or no potential for the water in the vacuum sensing chamber 26 to splash onto the face of the die 20, or onto the extrudate 22 as it exits the die 20. Such splashing, were it to occur, has the potential to introduce distortion and variations in the wall thickness of the hot extrudate 22 exiting the die 20. Given the absence of potential splashing from the closed vacuum sensing chamber 26, vacuum sensing chamber 26 can be positioned in close proximity to the die 20. For example, the entrance to vacuum sensing chamber 26 can be positioned about ¼-inch from the face of the die 20.

Locating the entrance to vacuum sensing chamber 26 in close proximity to the die 20, in turn, can eliminate any need for rollers or other supports that contact extrudate 22 as extrudate 22 travels through vacuum sensing chamber 26 and the tank 28, because the die 20 remains close enough to act as a cantilever support for the extrudate 22. Thus, there is little if any potential for drag, and distortion and variations in the wall thickness of extrudate 22, caused by contact between the hot exudate 22 and a supporting structure.

Although schematic implementations of present technology and at least some of its advantages are described in detail hereinabove, it should be understood that various changes, substitutions and alterations may be made to the apparatus and methods disclosed herein without departing from the spirit and scope of the invention as defined by the appended claims. The disclosed embodiments are therefore to be considered in all respects as being illustrative and not restrictive with the scope of the technology being indicated by the appended claims rather than by the foregoing description. All changes which come within the meaning and range of equivalency of the claims are therefore intended to be embraced therein. Moreover, the scope of this patent application is not intended to be limited to the particular implementations of apparatus and methods described in the specification, nor to any methods that may be described or inferentially understood by those skilled in the art to be present as described in this specification.

As disclosed above and from the foregoing description of exemplary embodiments of the technology, it will be readily apparent to those skilled in the art to which the technology pertains that the principles and particularly the compositions and methods disclosed herein can be used for applications other than those specifically mentioned. Further, as one of skill in the art will readily appreciate from the disclosure of the invention as set forth hereinabove, apparatus, methods, and steps presently existing or later developed, which perform substantially the same function or achieve substantially the same result as the corresponding embodiments described and disclosed hereinabove, may be utilized according to the description of the technology and the claims appended hereto. Accordingly, the appended claims are intended to include within their scope such apparatus, methods, and processes that provide the same result or which are, as a matter of law, embraced by the doctrine of the equivalents respecting the claims of this application.

As used in the claims appended hereto, the term “comprising” means “including but not limited to”, whereas the term “consisting of” means “having only and no more”, and the term “consisting essentially of” means “having only and no more except for minor additions which would be known to one of skill in the art as possibly needed for operation of the invention.” The scope of the appended claims, therefore, is indicated by the claims rather than by the foregoing description and all changes which come within the range of equivalency of the claims are to be considered to be embraced within the scope of the claims. Additional objects, other advantages, and further novel features of the technology will become apparent from study of the appended claims as well as from study of the foregoing detailed discussion and description of the preferred embodiments of the technology, as that study proceeds.

We claim:

1. A method for ultrasonically measuring an outer diameter of a tubular extrudate exiting an extrusion die, the improvement comprising:
providing a closed chamber having inlet and exit openings for passage therethrough of the tubular extrudate;
positioning a plurality of ultrasonic transducers within the chamber and spaced from the tubular extrudate;
controlling a water level in the chamber sufficiently to cover the transducers; and
automatic controlling and maintaining an internal pressure of the chamber at a level sufficiently below atmospheric pressure to preclude escape of water from the chamber through the inlet and exit openings as the tubular extrudate moves through the chamber.

2. The method of claim 1, further comprising
monitoring the water level in the chamber relative to the transducers;
introducing water into the chamber whenever the water level falls sufficiently that a top of one or more of the ultrasonic transducers is exposed; and
continuing introducing water into the chamber until the water level is above the tops of the one or more ultrasonic transducers by a preselected amount.

3. The method of claim 1, further comprising:
continuously monitoring the internal pressure of the chamber; and
lowering or raising the internal pressure of the chamber while flooding or draining water from the chamber to maintain the internal pressure of the chamber at a level sufficiently below atmospheric pressure to preclude escape of water from the chamber through the inlet and exit openings as the tubular extrudate moves through the chamber.

5. The method of claim 1, further comprising determining the outer diameter of the tubular extrudate based on an output of the one or more ultrasonic transducers.

6. The method of claim 1, further comprising:
providing a holder on which the one or more ultrasonic transducers are mounted; and
determining a position of the tubular extrudate in relation to the holder based on an output of the one or more ultrasonic transducers.

7. The method of claim 6, further comprising adjusting a position of the chamber in relation to the tubular extrudate.

8. The method of claim 7, wherein adjusting a position of the chamber in relation to the tubular extrudate comprises moving the chamber so that the tubular extrudate is substantially centered within the holder.

9. The method of claim 1, further comprising mounting the chamber on a cooling-medium tank.

10. An ultrasonic transducer fixture for measuring parameters of a moving tubular extrudate, comprising:
a closed chamber having an interior, and an entrance and an exit for passage of the tubular extrudate through the interior;
a holder positioned within the interior of the chamber;
a plurality of ultrasonic transducers mounted on the holder and positioned for passage of the tubular extrudate therebetween;
a vacuum source in fluid communication with the interior of the chamber and configured to maintain an internal pressure of the chamber at a level below atmospheric pressure;
a pump in fluid communication with the interior of the chamber; and
a control electrically connected to the pump and configured to generate an output that, when received by the pump, causes the pump to introduce water into the interior of the chamber to maintain a water level in the interior of the chamber above the tops of the one or more ultrasonic transducers.

11. The fixture of claim 10, wherein the control is electrically connected to the vacuum source and is further configured to generate another output that, when received by the vacuum source, causes the vacuum source to maintain the internal pressure of the chamber at a level sufficiently below atmospheric pressure to preclude escape of the water from the chamber through the entrance and exit as the tubular extrudate moves through the chamber.

12. The fixture of claim 10, further comprising a first iris valve mounted at the entrance of the chamber for passage therethrough of the tubular extrudate; and a second iris valve mounted at the exit of the chamber for passage therethrough of the tubular extrudate.

13. The fixture of claim 10, wherein the holder has a bore formed therein for passage therethrough of the tubular extrudate.

14. The fixture of claim 10, wherein the ultrasonic transducers are arranged on the holder in opposed pairs.

15. The fixture of claim 10, wherein the chamber has a first substantially vertical wall having the entrance to the chamber formed therein; and a second substantially vertical wall having the exit to the chamber formed therein.

16. The fixture of claim 10, wherein the chamber is configured to be mounted on a cooling-medium tank.

17. The fixture of claim 11, further comprising a water level sensor electrically connected to the control and configured to sense the water level in the interior of the chamber.

18. An apparatus, comprising:
an ultrasonic transducer fixture comprising: a vacuum chamber having an entrance for receiving a tubular extrudate from an extrusion die, and an exit; a holder within the vacuum chamber; a plurality of ultrasonic transducers mounted on the holder and positioned for passage of the tubular extrudate therebetween; and a vacuum source in fluid communication with an interior of the vacuum chamber and configured to maintain an internal pressure of the vacuum chamber at a level below atmospheric pressure; and
a cooling-medium tank, wherein the ultrasonic transducer fixture is mounted on the cooing-medium tank, and the cooling-medium tank has an entrance configured to receive the tubular extrudate after the tubular extrudate exits the vacuum chamber.

19. The apparatus of claim 18, wherein the cooling-medium tank and the vacuum chamber are configured to be movable in relation to the extrusion die.

20. The apparatus of claim 19, further comprising a signal processing device communicatively coupled to the ultrasonic transducers and configured to determine an outer diameter and a relative position of the tubular extrudate based on outputs of the ultrasonic transducers.

21. The apparatus of claim 20, further comprising:
one or more actuators mounted on the cooling-medium tank and configured to move the cooling-medium tank; and
a controller communicatively coupled to the one or more actuators and the signal processing device, wherein the controller is configured to generate an output that, when received by the one or more actuators, causes the one or more actuators to move the cooling-medium tank and the fixture.

22. The apparatus of claim 21, wherein the output of the controller, when received by the one or more actuators, causes the one or more actuators to move the cooling-medium tank and the fixture so that the tubular extrudate becomes centered within the holder.

23. The apparatus of claim 20, further comprising a video display communicatively coupled to the signal processing device, wherein the signal processing device, in response to the outputs of the ultrasonic transducers, is further configured to generate an output that, when received by the video display, causes the video display to display an image representative of an actual position of the tubular extrudate in relation to the one or more ultrasonic transducers, and in relation to an established target defined by the centerline of an intended path of the tubular extrudate through the holder and the tank.
